(19) United States
(12) Patent Application Publication
(10) Pub. No.: US 2012/0185501 A1
(43) Pub. Date: Jul. 19, 2012

(54) SYSTEMS AND METHODS FOR SEARCHING DATA

(76) Inventor: Ilya GELLER, Brooklyn, NY (US)

(21) Appl. No.: 13/324,192

(22) Filed: Dec. 13, 2011

Related U.S. Application Data
(60) Provisional application No. 61/433,875, filed on Jan. 18, 2011.

(51) Int. Cl. G06F 17/30

(52) U.S. Cl. 707/769; 707/E17.014

(57) ABSTRACT

A computer system implemented method of searching data comprising the steps of receiving a search phrase from an entity, the search phrase including at least one search phrase passage; extracting at least one predicative phrase from the search phrase passages of the search phrase; determining synonyms for the words in the extracted predicative phrases; creating synonymous predicative phrases from the synonyms creating a profile for the search phrase passages based on the extracted predicative phrases and the synonymous predicative phrases; accessing data that is to be searched; accessing profiles for the passages in the data to be searched; comparing the profiles of the search phrase passages to the profiles of the passages in the data to be searched based on compatibility or exact matching; retrieving predicative phrases from the data to be searched if their profiles are compatible with or match the profiles of the search phrase passages.

### INCORPORATION BY REFERENCE

U.S. Pat. No. 6,199,067 titled “System and method for generating personalized user profiles and for utilizing the generated user profiles to perform adaptive internet searches,” and issued to the same inventor.

### CROSS-REFERENCE TO RELATED APPLICATION

This application claims the benefit under 35 U.S.C. §119(e) of U.S. Provisional Patent Application No. 61/433,875, filed Jan. 18, 2011 entitled “ SYSTEMS AND METHODS FOR SEARCHING DATA,” the entire disclosure of which is incorporated by reference herein. This application also claims the benefit of priority under 35 U.S.C. 120 to pending U.S. application Ser. No. 12/714,980, filed Mar. 1, 2010 entitled “SYSTEMS AND METHODS FOR CREATING AN ARTIFICIAL INTELLIGENCE,” which is a non-provisional of and claims priority to U.S. Provisional Application Ser. No. 61/156,999, filed Mar. 3, 2009, entitled “SYSTEMS AND METHODS FOR CREATING AN ARTIFICIAL INTELLIGENCE,” the entire disclosure of which is incorporated by reference herein and to pending U.S. application Ser. No. 12/878,675, filed on Sep. 9, 2010, entitled “SYSTEMS AND METHODS FOR CREATING STRUCTURED DATA,” which is a non-provisional of and claims priority to U.S. Provisional Application Ser. No. 61/242,631, filed Sep. 15, 2009, entitled “SYSTEMS AND METHODS FOR CREATING STRUCTURED DATA,” the entire disclosure of which is incorporated by reference herein.

### FIELD OF THE INVENTION

The present invention is directed to the field of digital information processing.

### BACKGROUND OF THE INVENTION

In the modern world information is increasingly being stored digitally, and the volume of such digitally stored information is growing rapidly. Searching this volume of information and separating the wheat from the chafe is increasingly important, as well as difficult. The ability to quickly search and find relevant information in volumes of unrelated, or superfluous, information can be of utmost importance. Accordingly, the present invention is directed towards a system and method of facilitating electronic searching and tailoring results to personal interests.

### SUMMARY OF THE INVENTION

In one embodiment, there is disclosed a computer system implemented method of searching data. The method comprises the steps of receiving a search phrase from an entity, the search phrase including at least one search phrase passage; extracting at least one predicative phrase from the search phrase passages of the search phrase; determining synonyms for the words in the predicative phrases extracted from search phrase passages of the search phrase; creating synonymous predicative phrases from the synonyms creating a profile for the search phrase passages based on the extracted predicative phrases and the synonymous predicative phrases; accessing data that is to be searched; accessing profiles for the passages in the data to be searched; comparing the profiles of the search phrase passages to the profiles of the passages in the data to be searched based on compatibility or exact matching; and retrieving predicative phrases from the data to be searched if their profiles are compatible with or match the profiles of the search phrase passages.

In another embodiment, there is disclosed a computer system comprising a processor and memory. The computer system is configured to, receive a search phrase from an entity, the search phrase including at least one search phrase passage; extract at least one predicative phrase from the search phrase passages of the search phrase; determine synonyms for the words in the predicative phrases extracted from search phrase passages of the search phrase; create synonymous predicative phrases from the synonyms create a profile for the search phrase passages based on the extracted predicative phrases and the synonymous predicative phrases; access data that is to be searched; access profiles for the passages in the data to be searched: compare the profiles of the search phrase passages to the profiles of the passages in the data to be searched based on compatibility or exact matching; and retrieve predicative phrases from the data to be searched if their profiles are compatible with or match the profiles of the search phrase passages.

In another embodiment, there is disclosed a computer readable medium containing a program. The program is configured to performs the functions of receiving a search phrase from an entity, the search phrase including at least one search phrase passage; extracting at least one predicative phrase from the search phrase passages of the search phrase; determining synonyms for the words in the predicative phrases extracted from search phrase passages of the search phrase; creating synonymous predicative phrases from the synonyms creating a profile for the search phrase passages based on the extracted predicative phrases and the synonymous predicative phrases; accessing data that is to be searched; accessing profiles for the passages in the data to be searched; comparing the profiles of the search phrase passages to the profiles of the passages in the data to be searched based on compatibility or exact matching; and retrieving predicative phrase passages from the data to be searched if their profiles are compatible with or match the profiles of the search phrase passages.

### BRIEF DESCRIPTION OF THE FIGURES

FIG. 1 is flow chart diagram of an exemplary embodiment of the present invention.

### DETAILED DESCRIPTION

Certain embodiments of the present invention will be discussed and it should be noted that references in the specification to phrases such as “one embodiment” or “an embodiment” means that a particular feature, structure or characteristic described in connection with the embodiment is included in at least one embodiment of the invention. The appearance of phrases such as “in one embodiment” in various places in the specification are not necessarily, but can be, referring to same embodiment.

In an embodiment of the invention, a computer system is specifically programmed to convert search phrases into structured data while minimizing lexical noise which preferably improves the accuracy of search and personalization of the search results for the searcher's specific interests.

The computer system preferably includes such art recognized components as are ordinarily found in computer systems, including but not limited to processors, RAM, ROM, clocks, hardware drivers, associated storage, and the like. The computer-based system may include servers and connections to networks such as the Internet, Intranet, LAN, or other communication networks. The programming loaded on the computer system may be created in any programming language presently known or hereafter developed, for example, C, C++, JAVA, and C#.

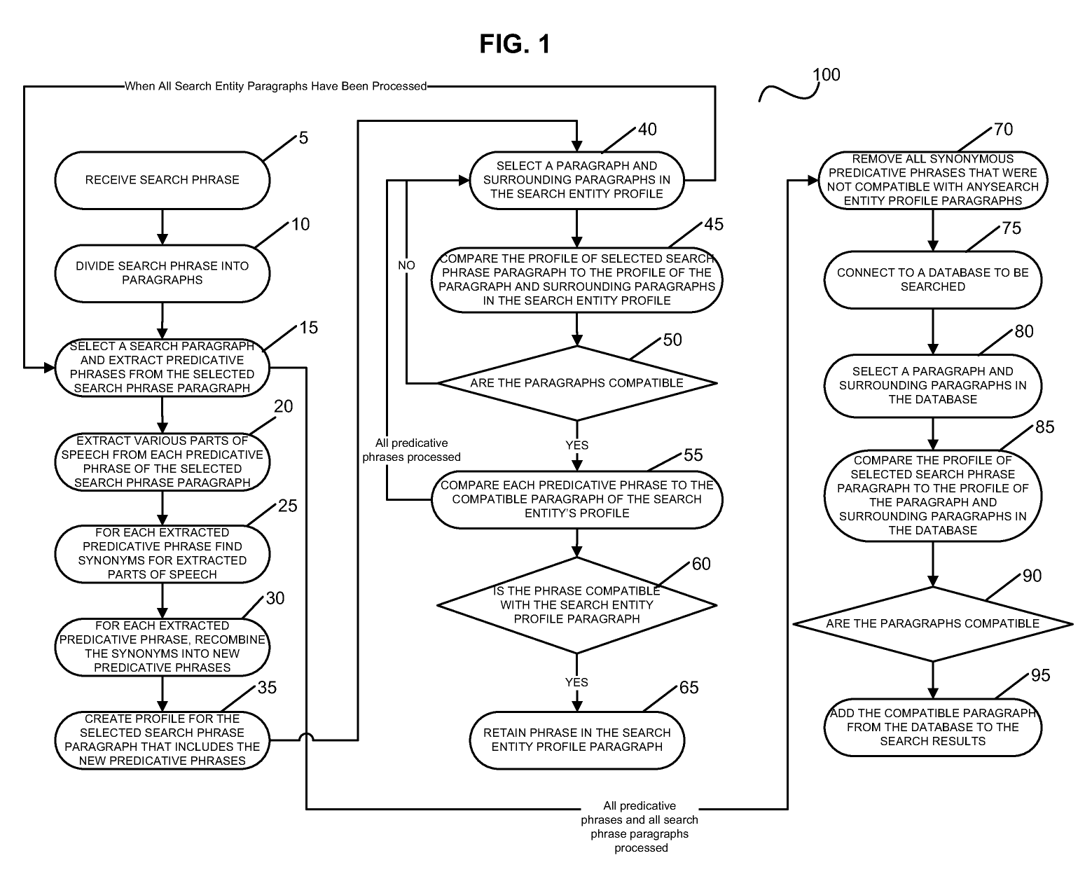

With reference to FIG. 1, an embodiment of the process 100 may commence, in step 5 with the computer system receiving a text search phrase (“Search Phrase”). This phrase may come from a user, another computer system or an automated process or any other source. The Search Phrase may be any number of words which may comprise any number of passages, sentences, paragraphs, and chapters.

In step 10, the Search Phrase is preferably divided into paragraphs. A paragraph is a subdivision of a written composition that comprises of one or more sentences, deals with one or more points/ideas, or gives the words of one speaker by way of example, and can be extracted from text based upon textual indicators such as, for example, a hard return or tab (although any other suitable means or algorithm may be used). If the search phrase is less than an entire paragraph, for example it is a phrase, it will be preferably treated as a paragraph. In certain embodiments passages are used in lieu or in addition to paragraphs. A passage can be any amount of text though it is preferably treated like a paragraph and may be a paragraph.

In alternate embodiments the Search Phrase may also, or alternatively, be divided into chapters, each of which may contain one or more paragraphs and may be extracted from text based upon textual indicators such as, for example, a title, although other methods may be used.

Starting with step 15, the computer system preferably commences a recursive process that is performed, in a preferred embodiment, on each paragraph in the search phrase, proceeding from first to last paragraph. In step 15, the computer system selects a paragraph from the search phrase (“Selected Search Phrase Paragraph”). It should be noted that the invention is not limited to any method of traversing the paragraphs and, in alternate embodiments, the paragraphs may be traversed in any order with or without regard to the order of the paragraphs in the text. In certain embodiments of the invention, a profile may be created for the entire Search Phrase, or a part thereof.

In step 20 predicative phrases are preferably extracted from each sentence or clause that exists in the Selected Search Phrase Paragraph. Clauses in complex sentences may be identified, by way of example, through the use of grammar rules, for example, by identifying commas and semicolons and presence of multiple predicates, or any other suitable algorithm. A predicative phrase is a predicative definition preferably characterized by combinations of nouns and other parts of speech, such as a verb and an adjective and an article (e.g., the-grey-city-is). The terms predicative phrase, predicative definition, and predicative clause are used interchangeably herein. In the preferred embodiment, each predicative phrase is a combination of an article, noun, verb, and adjective, although in alternate embodiments various combinations of nouns and verbs and other figures of speech may be utilized, for example, noun, verb, and adverb. Predicative phrases convey the central idea or ideas contained within a given sentence.

In certain embodiments, when extracting predicative phrases, the system may be configured to control for common noun phrases, idioms, or similar phrases. For example, “hot dog” may be treated as a noun as opposed to a noun plus an adjective. Such idiomatic phrases may be determined using an encyclopedia, dictionary or other similar database or text. Additionally, idioms such as “under the weather” may be treated as a single adjective. These noun phrases and idioms may be identified based upon a database of common phrases or idioms, but the system is not limited to any specific way of identifying them. Additionally, the definitions of idioms retrieved from, for example, encyclopedias may be used to extract or generate predicative definitions related to the idiom.

In step 25, each of the predicative phrases extracted in step 20 is separated into individual words and synonyms are preferably located for each one of those individual words. Synonyms may be located using, for example, a thesaurus database that may be stored locally or accessed via the internet. Synonyms may be selected without regard to the part of speech, for example if the word is a noun but its synonym is a verb, the verb synonym may still be used as part of a synonymous predicative definition.

In step 30, for each predicative phrase the extracted words and their synonyms are preferably recombined into all possible alternate versions of each predicative phrase. This may be performed according to methods described in U.S. Pat. No. 6,199,067, which is incorporated in its entirety herein by reference, although any other applicable method may be used and not every possible synonymous phrase needs to be created.

In step 35, a profile is compiled for the Selected Search Phrase Paragraph of the search phrase. The profile of a paragraph typically includes the predicative phrases of the paragraph, and their respective weight, or importance, within that paragraph. A synonymous predicative definition is preferably treated as having the same weight as the original predicative definition from which it was generated, however, alternate weights may be assigned. The profile of a paragraph is essentially a summary of the theme or themes of a paragraph and it may include lexical noise. In other embodiments, profiles may also be created for the entire text or a part thereof. Such profiles would include the predicative phrases in the text, or a part thereof, and references to the paragraphs from which those phrases originated preferably saved into metadata. In certain embodiments the profiles could include the weights of the predicative phrases.

In the exemplary algorithm, determination of the weight of a predicative phrase in a paragraph, is preferably performed by first analyzing the weight of the predicative phrase in each sentence of the paragraph. Each clause of a sentence may be treated as an individual sentence—the clauses may be determined based upon figures of speech and punctuation marks. For each such sentence, the number of all predicative phrases that occur in that sentence is calculated. For example, if there are 24 different predicative phrases in a sentence, then the weight of each phrase in the text is 1/24.

To determine the weight of a predicative phrase in the paragraph, the weights of the relevant predicative phrases in each sentence of the paragraph are added together. For example, if there are four sentences and the weights of the relevant predicative phrase are 1/24, ¼, ⅙, and ½, then the weight of the predicative phrase in the paragraph is 23/24.

Additionally, because paragraphs can be different lengths, in order to improve accuracy of the matching, the weight of the predicative phrase in each paragraph may be further weighted based on the size of the entire paragraph. For example, if the paragraph is 120 words then the weight of the predicative phrase in that paragraph is divided by 120: (23/24)/120. In the embodiments that use absolute weights the length of the paragraph is preferably ignored and thus, if, for example, a predicative phrase is present 5 times in one paragraph, the final weight of that phrase in that paragraph is 5. It should be noted this algorithm is exemplary, and alternate algorithms may be used within the scope of this invention so long as the desired accuracy in matching is achieved.

It should be further noted that although the process is described as being linear, and recursive, in alternate embodiments the steps can be performed simultaneously or several at a time, for example steps 15-35 may be performed on all search phrase paragraphs, simultaneously, using, for example parallel processing and before step 40.

The computer system then accesses the profile of the entity performing a search (“Searching Entity Profile”). The Searching Entity Profile preferably contains texts related to the searcher, e.g., books, magazines, articles, emails, blogs entries, article comments and/or social network posts that the user has read, written, or is interested in, and preferably the profiles of those texts which preferably include the predicative phrases of the paragraphs within those texts and their those predicative phrases' weights. The Searching Entity Profile may be stored locally or remotely. In an exemplary embodiment, the searcher's profile has been created according to the methods of U.S. patent application Ser. No. 12/714,980 titled “SYSTEMS AND METHODS FOR CREATING AN ARTIFICIAL INTELLIGENCE,” which is incorporated by reference in its entirety herein.

In steps 40-50, the system recursively compares the profile of the Selected Search Phrase Paragraph to each paragraph in the Searching Entity Profile. In step 40, the system selects a text paragraph within the Searching Entity Profile (“Selected Entity Profile Paragraph”) as well as the paragraph or paragraphs immediately prior and the paragraph or paragraphs immediately subsequent (“Surrounding Paragraphs”) in order to determine the compatibility between the Selected Search Phrase Paragraph and the themes or contexts and/or optionally the subtext of the text surrounding the Selected Entity Profile Paragraph. If the Selected Entity Profile Paragraph happens to be the first paragraph of the text or the chapter, then the profile of the Selected Search Phrase Paragraph can be compared to the profile Selected Paragraph and profiles of some, for example, two-three, paragraphs subsequent thereto. Similarly, if the Selected Entity Profile Paragraph is the last paragraph, then the profile of the Selected Search Phrase Paragraph can be compared to the profile of the Selected Entity Profile Paragraph and profiles of two-three preceding paragraphs. An exemplary method of determining compatibility is described in further detail below. It should understood that in alternate embodiments, textual passages that are smaller or larger can be used instead of Selected Entity Profile Paragraph and Surrounding Paragraphs including, but not limited to, sentences, clauses, or phrases. Additionally, in embodiments, the profiles of paragraphs or passages that are adjacent to the Selected Search Phrase Paragraph may be used in the comparison to the Selected Entity Profile Paragraph and Surrounding Paragraphs.

In step 50, the compatibility between the profile of the Selected Search Phrase Paragraph and either one of the profiles of the Selected Entity Profile Paragraph or the Surrounding Paragraphs is determined, and if it exceeds a certain threshold then, in step 55, the system recursively compares each of the predicative phrases of the Selected Search Phrase Paragraph to the predicative phrases from the profile of the Selected Entity Profile Paragraph and, if, in step 60, the compatibility between them is above a certain threshold, then the predicative phrase is retained in the Selected Search Phrase Paragraph profile in step 65. Otherwise if the profiles are not compatible the predicative phrase/phrases that were not compatible is/are excluded after all Selected Entity Profile Paragraphs have been analyzed. In other embodiments, a predicative phrase may be instantly excluded if the compatibility does not match some compatibility value that may be either selected or calculated according to a suitable formula or algorithm. This is because a sufficient compatibility may indicate the relevance of the synonymous predictive phrase to the interests of the user. By performing steps 40-70, the lexical noise resulting from less pertinent synonymous predicative phrases may be minimized. It should be noted that reduction of lexical noise is optional. Moreover, if the profile of the Searching Entity is empty, then all synonymous predicative definitions are preferably included in the profiles of the Search Phrase Paragraphs.

In an embodiment of the present invention, after step 70, the system will have a Search Phrase Profile that includes relevant synonymous predicative definition for each Search Phrase Paragraph and a search may be performed across a database that the searching entity intends to search.

In step 75 the system connects to the database to be searched. In steps 80-95, the system recursively compares the profiles of the Search Phrase Paragraph and/or Paragraphs to each paragraph in the database being searched. In step 80 the system selects a text paragraph within the database (“Selected Database Paragraph”) as well as the paragraph or paragraphs immediately prior and the paragraph or paragraphs immediately subsequent (“Database Surrounding Paragraphs”) in order to determine the compatibility between the Selected Search Phrase Paragraph and the themes or contexts and/or optionally the subtext of the text surrounding the Selected Database Paragraph. If the Selected Database Paragraph happens to be the first paragraph of the text or the chapter, then the profile of the Search Phrase Paragraph is compared to the profile of the Selected Database Paragraph and profiles of some, for example, two-three, paragraphs subsequent thereto. Similarly, if the Selected Database Paragraph is the last paragraph, then the profile of the Search Phrase Paragraph is compared to the profile of the Selected Database Paragraph and profiles of two-three preceding paragraphs. An exemplary method of determining compatibility is described in further detail below.

If, in step 90, it is determined that the compatibility between the profile of the Selected Search Phrase Paragraph and either one of the profiles of the Selected Database Paragraph and the Database Surrounding Paragraphs exceeds a certain threshold then, in Step 95 the system adds the Selected Database Paragraph to the search results. The search results may then be displayed to the search entity, stored, or have another operation performed on them, for example sorting.

Within the context of steps 40 and 80, in order to utilize a substantial sample of context and/or subtext of text when determining relevance, the paragraphs that precede and follow the Surrounding Paragraphs are preferably defined as being at least 200 words long. Other lengths are also contemplated herein. Therefore, for example, if the Selected Entity Profile Paragraph is preceded by a paragraph that is less than 200 words, then the computer system preferably considers further preceding paragraphs, until the number of words within the preceding paragraphs equals or is greater than 200 words. Thus, if the Database Paragraph is in the middle of a chapter, it will be preceded and followed by at least 200 words, and if the Selected Paragraph is first or last paragraph it will be followed or preceded by at least 400 words, respectively. It should be noted, that the invention should not be limited to any specific number of words or paragraphs.

One exemplary method of determining compatibility between paragraph profiles profile, may be based upon a compatibility algorithm, such as:

$$Compatibility = \frac{Sum ( \begin{matrix}Weight of the same phrase in {Text}_{1} * \\ Weight of the smae phrase in {Text}_{2}\end{matrix} )}{Sqrt ( \begin{matrix}Sum ( Weighy of each phrase in {Text}_{1}^{2} ) * \\ Sum ( Weight of each phrase in {Text}_{2}^{2} )\end{matrix} )}$$

where the weight refers to the frequency that a predicative phrase occurs in relation to other predicative phrases. In the preferred embodiment the satisfactory compatibility score may be set according to a number such as at least 20, while in other embodiments it could be a formula such as greater than the average of all compatibilities between paragraphs, any other score or compatibility algorithm and resulting scores, may be utilized.

Since textual information is often not perfect in terms of grammar or spelling, in certain embodiments it may be advantageous to include methods of extracting predicative phrases from sentences that include missing subjects, missing predicates, and/or other grammatical mistakes or oddities. Such a method is preferably incorporated into step 20, although it may be incorporated at other times, for example, before starting process 100.

In certain embodiments of the present invention the computer system may compensate for clauses or sentences that are missing subjects, predicates, or adjectives. To compensate for a missing predicate, the verb “be” or one of its forms (e.g., “is,” “are,” “were,” and “was”) may be used when extracting predicative phrases from the sentence or clause, where the selection of the plurality and tense of the verb “be” is preferably based upon rules of grammar and the contexts and subtexts of the surrounding sentences.

For sentences or clauses that are missing a subject, the computer system may add to the sentence a pronoun “it,” “I,” “he,” “she,” “we,” “they” may be used when extracting predicative phrases from the sentence or sentence, where the selection of the form of the pronoun is preferably selected based upon rules of grammar and the contexts and subtexts of the surrounding sentences. This may be based on compatibility where a the clause without a subject is compared to the predicative clauses of the surrounding sentences and paragraphs and the missing subject is replaced with the pronoun that matches the subject of the most compatible phrase. For example, if the sentences that surround the given sentence or clause (that is lacking a subject) are about a woman, then the pronoun “she” is preferably added to the clause that is lacking a subject.

Moreover, in certain embodiments, the method of utilizing synonyms may be combined with the method of replacing missing subjects with pronouns and/or proper names. By way of example and not limitation, if a given text contained the predicative phrase “be-good” and the closest match by compatibility is “trees-be-nice,” then the missing subject in “be-good” may be filled in by “it” or “tree” providing one original and two alternative synonymous phrases: “be-good,” “tree-be-good,” and “it-be-good.” In certain embodiments, if the sentences that surround a selected sentence or clause that lacks a subject are about a woman named Ellen, then the proper name “Ellen” and/or pronoun “she” is preferably added to the clause that is lacking a subject: e.g., if a given text contained the predicative phrase “_-be-good” and the closest match by compatibility is “Ellen-be-nice,” then the missing subject in “_-be-good” may be substituted with “Ellen” or “she” providing one original and two alternative synonymous phrases: “Ellen-be-good,” “she-be-good,” and “_-be-good.” Some, all, or none of these synonymous phrases may be saved in the profile of the text depending on the algorithm used. Furthermore, in various embodiments synonyms for tree may be located and used to create further synonymous predicative phrases.

It should be noted that addition of missing subjects or predicates do not have to be performed together, and algorithms other than the ones described may be used to add subjects or predicates to sentences or clauses that lack them, for example by using the subject or predicate of the immediately preceding clause or sentence or some alternative algorithm that accounts for the missing subject and/or predicate.

The system may also be configured to handle clauses or sentences that include no parts of speech beside the noun/verb subject/predicate pair. In those instances, the computer system may add a preposition/adjective “in” when extracting predicative phrases from the sentence, although other prepositions may be used and additional or alternative parts of speech may be added such as an article.

Although the present invention and its advantages have been described in detail, it should be understood that various changes, substitutions, and alterations readily apparent to those skilled in the art may be made without departing from the spirit and the scope of the present invention as defined by the following claims.

What is claimed is:

1. A computer system implemented method of searching data comprising the steps of:
receiving a search phrase from an entity, the search phrase including at least one search phrase passage;
extracting at least one predicative phrase from the search phrase passages of the search phrase;
determining synonyms for the words in the predicative phrases extracted from search phrase passages of the search phrase;
creating synonymous predicative phrases from the synonyms
creating a profile for the search phrase passages based on the extracted predicative phrases and the synonymous predicative phrases;
accessing data that is to be searched;
accessing profiles for the passages in the data to be searched;
comparing the profiles of the search phrase passages to the profiles of the passages in the data to be searched based on compatibility or exact matching;
retrieving predicative phrases from the data to be searched if their profiles are compatible with or match the profiles of the search phrase passages.

2. The method of claim 1 further comprising, after the step of creating synonymous predicative phrases, the steps of:
accessing a profile of the entity from which the search phrase was received, wherein the profile is configured to include textual information associated with the entity;
comparing the synonymous predicative phrases to the passages of the textual information of the profile based on compatibility or exact matching;
removing synonymous predicative phrases that are not compatible.

3. The method of claim 1 further comprising:
accessing a profile of the entity from which the search phrase was received, wherein the profile is configured to include textual information associated with the entity;
comparing the profiles of the search phrase passages to the profiles of the passages in the data to the passages of the textual information of the profile based on compatibility;
adding the search phrase passages that are compatible with the passages of the search entity's profile to the search entity's profile.

4. The method of claim 1 wherein the step of extracting at least one predicative phrase from the search phrase passages of the search phrase further includes the steps of;
adding missing subjects to predicative phrases by filling in the appropriate pronoun based upon the rules of grammar and surrounding sentences.

5. The method of claim 1 further comprising the step of displaying the predicative phrases retrieved from the data to be searched.

6. The method of claim 1 wherein the data to be searched is accessed via the internet.

7. A computer system comprising:
a processor and memory configured to, receive a search phrase from an entity, the search phrase including at least one search phrase passage;
extract at least one predicative phrase from the search phrase passages of the search phrase;
determine synonyms for the words in the predicative phrases extracted from search phrase passages of the search phrase;
create synonymous predicative phrases from the synonyms
create a profile for the search phrase passages based on the extracted predicative phrases and the synonymous predicative phrases;
access data that is to be searched;
access profiles for the passages in the data to be searched;
compare the profiles of the search phrase passages to the profiles of the passages in the data to be searched based on compatibility or exact matching;
retrieve predicative phrases from the data to be searched if their profiles are compatible with or match the profiles of the search phrase passages.

8. The system of claim 7, wherein the memory and processor are further configured to:
access a profile of the entity from which the search phrase was received, wherein the profile is configured to include textual information associated with the entity;
compare the synonymous predicative phrases to the passages of the textual information of the profile based on compatibility or exact matching;
remove synonymous predicative phrases that are not compatible, before creating a profile for the search phrase passages.

9. The system of claim 7, wherein the memory and processor are further configured to:
access a profile of the entity from which the search phrase was received, wherein the profile is configured to include textual information associated with the entity;
compare the profiles of the search phrase passages to the profiles of the passages in the data to the passages of the textual information of the profile based on compatibility;
add the search phrase passages that are compatible with the passages of the search entity's profile to the search entity's profile.

10. The system of claim 7, wherein the memory and processor are further configured to:
add missing subjects to predicative phrases by filling in the appropriate pronoun based upon the rules of grammar and surrounding sentences when extracting at least one predicative phrase from the search phrase passages of the search phrase

11. The system of claim 7, wherein the memory and processor are further configured to display the predicative phrases retrieved from the data to be searched on the display.

12. The system of claim 7, wherein the data to be searched is accessed via the internet.

13. A computer readable medium containing a program which performs the functions of:
receiving a search phrase from an entity, the search phrase including at least one search phrase passage;
extracting at least one predicative phrase from the search phrase passages of the search phrase;
determining synonyms for the words in the predicative phrases extracted from search phrase passages of the search phrase;
creating synonymous predicative phrases from the synonyms
creating a profile for the search phrase passages based on the extracted predicative phrases and the synonymous predicative phrases;
accessing data that is to be searched;
accessing profiles for the passages in the data to be searched;
comparing the profiles of the search phrase passages to the profiles of the passages in the data to be searched based on compatibility or exact matching;
retrieving predicative phrase passages from the data to be searched if their profiles are compatible with or match the profiles of the search phrase passages.

14. The medium of claim 13 wherein, after the step of creating synonymous predicative phrases, the program performs the further steps of:
accessing a profile of the entity from which the search phrase was received, wherein the profile is configured to include textual information associated with the entity;
comparing the synonymous predicative phrases to the passages of the textual information of the profile based on compatibility or exact matching;
removing synonymous predicative phrases that are not compatible.

15. The medium of claim 13 wherein the program performs the further steps of:
accessing a profile of the entity from which the search phrase was received, wherein the profile is configured to include textual information associated with the entity;
comparing the profiles of the search phrase passages to the profiles of the passages in the data to the passages of the textual information of the profile based on compatibility;
adding the search phrase passages that are compatible with the passages of the search entity's profile to the search entity's profile.

16. The medium of claim 13 wherein the step of extracting at least one predicative phrase from the search phrase passages of the search phrase further includes the steps of;
adding missing subjects to predicative phrases by filling in the appropriate pronoun based upon the rules of grammar and surrounding sentences.

17. The medium of claim 13 wherein the program performs the further step of displaying the passages retrieved from the data to be searched.
